(19) United States
(12) Patent Application Publication
(10) Pub. No.: US 2026/0039013 A1
(43) Pub. Date: Feb. 5, 2026

(54) ANTENNA DEVICE

(71) Applicant: DENSO CORPORATION, Kariya-city (JP)

(72) Inventors: Youhei SEKIYA, Nisshin-city (JP); Yuuji KAKUYA, Kariya-city (JP)

(21) Appl. No.: 19/358,109

(22) Filed: Oct. 14, 2025

Related U.S. Application Data
(63) Continuation of application No. PCT/JP2024/012212, filed on Mar. 27, 2024.

(30) Foreign Application Priority Data
Apr. 24, 2023 (JP) 2023-071011

(51) Int. Cl. H01Q 1/32; H01Q 9/04; H01Q 9/26

(52) U.S. Cl. CPC H01Q 1/3283; H01Q 9/0421; H01Q 9/26

(57) ABSTRACT

An antenna device includes a substrate, a ground plate, a first element, and a second element. The substrate is a plate-shaped dielectric. The ground plate is a plate-shaped conductor provided on or inside the substrate. The first element is a liner conductive element extending along the surface of the substrate. The second element is a liner conductive element having a three-dimensional shape. The second element includes a standing portion perpendicular to the substrate and a substrate parallel portion extending from an upper end of the standing portion in a direction parallel to the substrate. The substrate parallel portion includes a portion that is parallel to a part of the first element. One of ends: a lower end of the standing portion and an end of the first element, is connected to a feed line, and another of the ends is electrically connected to the ground plate.

### CROSS REFERENCE TO RELATED APPLICATIONS

The present application is a continuation application of International Patent Application No. PCT/JP2024/012212 filed on Mar. 27, 2024, which designated the U.S. and claims the benefit of priority from Japanese Patent Application No. 2023-071011 filed on Apr. 24, 2023. The disclosures of all the above applications are incorporated herein.

### TECHNICAL FIELD

The present disclosure relates to an antenna device.

### BACKGROUND

A patch antenna is attached to a side section of a vehicle (e.g., side sill) and performs wireless communication with a portable device carried by a user.

### SUMMARY

According to at least one embodiment of the present disclosure, an antenna device includes a substrate, a ground plate, a first element, and a second element. The substrate is a plate-shaped dielectric. The ground plate is a plate-shaped conductor provided on a surface of the substrate or inside the substrate. The first element is a liner conductive element extending along the surface of the substrate. The second element is a liner conductive element having a three-dimensional shape. The second element includes a standing portion perpendicular to the substrate and a substrate parallel portion extending from an upper end of the standing portion in a direction parallel to the substrate. The substrate parallel portion includes a portion that is parallel to a part of the first element. One of ends: a lower end of the standing portion and an end of the first element, is connected to a feed line, and another of the ends is electrically connected to the ground plate.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a perspective view of an antenna device.

FIG. 2 is a top view of the antenna device.

FIG. 3 is a side view of the antenna device.

FIG. 4 is a diagram conceptually illustrating a current distribution of a first model.

FIG. 5 is a diagram conceptually illustrating a current distribution of a second model.

FIG. 6 is a diagram illustrating a directivity of the second model.

FIG. 7 is a diagram conceptually illustrating a current distribution of a third model.

FIG. 8 is a diagram illustrating a directivity of the third model.

FIG. 9 is a view showing an antenna device including a support for fixing a second element.

FIG. 10 is a view showing the second element fixed to a housing.

FIG. 11 is a view showing a second element including two standing portions.

FIG. 12 is a view showing a first element formed in an L-shape.

FIG. 13 is a diagram illustrating another example of formation of the first element and the second element.

FIG. 14 is a view showing a positional relationship between a cable connection terminal end and a three-dimensional antenna.

FIG. 15 is a diagram illustrating the antenna device including two three-dimensional antennas.

FIG. 16 is a diagram illustrating the antenna device including two three-dimensional antennas and one pattern antenna.

FIG. 17 is a diagram showing an example of a mounting position of the antenna device in a vehicle.

### DETAILED DESCRIPTIONS

A first comparative example discloses a system that uses a patch antenna attached to a side section of a vehicle (e.g., side sill) and performs wireless communication with a portable device carried by a user.

In recent years, a technology has been explored in which a distance from a vehicle to a portable device is determined by ranging communication using a short-range communication signal performed between an in-vehicle communication device placed on an exterior of a vehicle (e.g., side body) and the portable device. The short-range communication signal is a wireless signal conforming to short-range communication standards such as Bluetooth (registered trademark) Low Energy.

For the short-range communication, a radio wave of 900 MHz or higher, such as 2.4 GHz or 920 MHz (hereinafter referred to as high-frequency radio wave) is used. The short-range communication signal that uses the high-frequency radio wave have a stronger tendency to travel straight compared to a radio wave in the LF (Low Frequency) band. Thus, the patch antenna attached to and extending along the side body is less likely to receive a direct wave (diffracted wave) from the portable device located near a rear door.

Additionally, since the short-range communication signal is the high-frequency radio wave, they tend to be reflected by reflective objects such as bodies of other vehicles and walls. Thus, if there is a reflective object around a vehicle, a received signal strength of a reflected wave may exceed a received signal strength of a diffracted wave. If the received signal strength of the reflected wave is greater than the received signal strength of the diffracted wave, the distance will be calculated based on components of the reflected wave, which may reduce a distance measurement accuracy. For this reason, there may be a demand for an antenna that has a higher gain in a substrate horizontal direction than in a substrate vertical direction so that the direct wave (diffracted wave) from a portable device that is out of line-of-sight can be reliably received. The substrate vertical direction means a direction perpendicular to a substrate on which the antenna and the like are mounted, and the substrate horizontal direction means a direction along (parallel to) the substrate. Also, there may be a demand for reducing a height of an antenna mounted on a vehicle.

According to the present disclosure, an antenna device is capable of reducing a height of the antenna and has a higher gain in a substrate horizontal direction than in a substrate vertical direction.

One of the antenna devices disclosed here includes a substrate that is a plate-shaped dielectric, a ground plate that is a plate-shaped conductor provided on the surface or inside the substrate, a first element that is a linear conductor element provided along the surface of the substrate, and a second element that is a linear conductor element having a three-dimensional shape. The second element includes a standing portion perpendicular to the substrate, and a substrate parallel portion extending from an upper end of the standing portion in a direction parallel to the substrate. The substrate parallel portion includes a portion that is parallel to a part of the first element. One of ends: a lower end of the standing portion and one end of the first element, is connected to a feed line, and another of the ends is electrically connected to the ground plate.

According to the above configuration, a current, flowing in the portion of the substrate parallel portion that is parallel to the first element, cancels out a part of a current flowing in the first element. Therefore, the radio wave generated by the current flowing in a direction parallel to the substrate is weakened, and the radio wave generated by the current flowing in the standing portion is relatively stronger. The radio wave generated from the standing portion propagates in a direction perpendicular to the standing portion, i.e., in the substrate horizontal direction. In other words, according to the above configuration, a gain in the substrate horizontal direction can be made larger than a gain in the substrate vertical direction. Additionally, the above second element may have a shape in which a linear conductive element is bent at an intermediate point. Therefore, a height of the antenna device can be reduced.

Hereinafter, embodiments of the present disclosure will be described with reference to the drawings. The present disclosure is not limited to the following embodiments, and various modifications described below are also included in a technical scope of the present disclosure. Furthermore, a configuration of the present disclosure may be modified as long as not departing from the scope of the present disclosure. The various supplements and modifications may be implemented in any suitable combination as long as no technical contradictions arise. For components having the same function, the same reference numerals are used, and their descriptions may be omitted. Furthermore, when only a part of the configuration is described, other parts may incorporate explanations described in other sections of the present disclosure. In the following embodiments, portions that are the same as or equivalent to those described in a preceding embodiment are denoted by the same reference numerals, and a description of the same or equivalent portions may be omitted. When only some of the configuration elements are described in the embodiment, the remaining configuration elements can be referred from those described in a preceding embodiment. The following embodiments may be partially combined with each other even if such a combination is not explicitly described as long as there is no disadvantage with respect to such a combination.

An antenna device 1 of the present disclosure is used, for example, by being attached to a mobile object such as a vehicle. The antenna device 1 may be attached to, for example, a side section (i.e., a side body), a rear section, a front section, or/and a roof section. The antenna device 1 is used by being connected to a communication ECU (Electronic Control Unit) mounted on a vehicle, via one or more cables. The ECU may use a signal received by the antenna device 1, and may input a transmission signal to the antenna device 1.

The antenna device 1 is configured to operate in the 2.4 GHz band (2402 MHz to 2480 MHZ) used for Bluetooth (registered trademark). The antenna device 1 may be used for only one of transmission or reception. Since the transmission and reception of a radio wave are reversible, a configuration capable of transmitting a radio wave of a certain frequency is also a configuration capable of receiving the radio wave of the frequency. The term “transmission/reception” described below may be interpreted as “transmission and/or reception.”

In the present disclosure, a frequency band in which the antenna device 1 operates is referred to as a target frequency band. Additionally, among frequencies belonging to the target frequency band, a frequency used as a reference for designing the antenna device 1 is referred to as a target frequency. The target frequency may be a center frequency of the target frequency band. Hereinafter, a case where the target frequency is set to 2440 MHz will be described. The target frequency may be set to a value slightly higher (for example, by 10 MHZ) than the center frequency. Additionally, the target frequency may be set to a minimum frequency or a maximum frequency of the target frequency band.

Hereinafter, “λ” represents a target wavelength, which is the wavelength of the radio wave at the target frequency. In the present disclosure, expressions “λ/2” and “0.5λ” mean a length equal to half the target wavelength. Expressions using the wavelength (λ), such as “λ/2” and “λ/4,” will be used to describe dimensions of various components. The wavelength (λ) used in the descriptions of dimensions of components constituting the antenna device 1 may be interpreted as an electrical length. The electrical length is an effective length in consideration of a fringing electric field and a wavelength shortening effect caused by a dielectric. The electrical length may also be referred to as the effective length. Additionally, the wavelength (i.e., λ) of a radio wave whose frequency is 2440 MHz in vacuum and in air is 122.8 mm. Thus, the expression “λ/4” means approximately 30.7 mm. Of course, since components in contact with the dielectric are subject to the wavelength shortening effect, a length corresponding to λ/4 may become, for example, 20 mm or 25 mm. Those skilled in the art can identify the dimension corresponding to λ/4 by using a simulator or the like.

In other embodiments, the target frequency band may be a 2.4 GHz and 5 GHz used for Wi-Fi (registered trademark). The antenna device 1 may support a frequency band used in UWB communication. The target frequency band may confirm to other short-range wireless communication standards.

### Specific Configuration of the Antenna Device 1

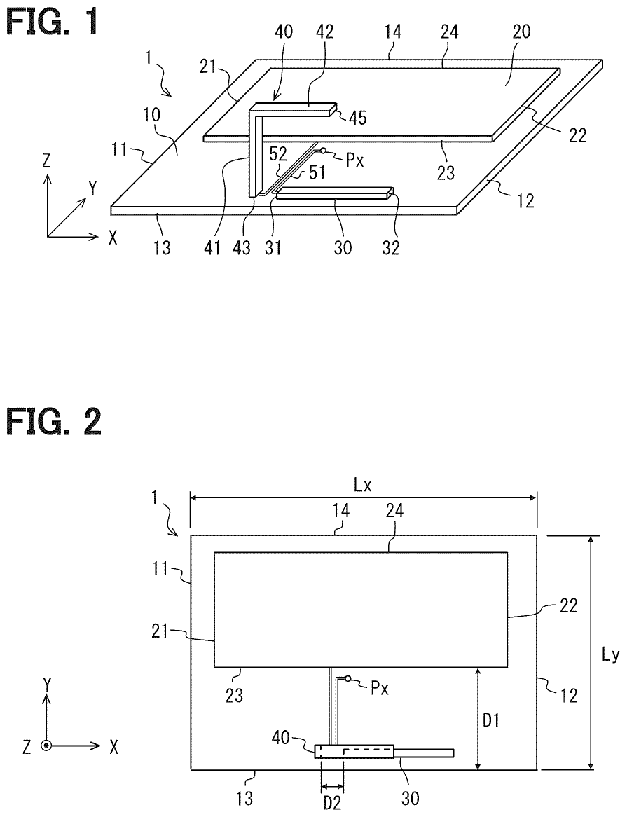

As shown in FIGS. 1 to 3, the antenna device 1 includes a substrate 10, a ground plate 20, a first element 30, a second element 40, a feed line 51, and a short-circuit line 52. The first element 30 and the second element 40 are designed to operate as a dipole antenna, as described below. Hereinafter, a configuration including the first element 30 and the second element 40 may be referred to as an element set or a three-dimensional antenna.

Furthermore, the antenna device 1 may include components that are not shown in FIGS. 1 to 3, such as a connector, a power supply circuit, a communication IC, and a housing. The connector is a component for a connection of a communication cable and a power cable. The communication cable is a cable for communicating with the ECU. The communication cable may be a coaxial cable or a feeder line. The power cable is a cable for supplying power to the antenna device 1. This cable may be referred to as an electric wire. The communication cable and the power cable may be bundled together as a single harness. The communication cable and the power cable may be integrated. The power supply circuit is a circuit that converts a voltage (e.g., battery voltage) input from the power cable into a voltage suitable for an operation of the communication IC and outputs the converted voltage.

The communication IC is an integrated circuit module for performing signal processing on transmitted and received signals. The communication IC performs, for example, modulation, demodulation, frequency conversion, and amplification. The communication IC includes a ground terminal and an antenna connection terminal. The ground terminal is a terminal that is electrically connected to the ground plate 20. The antenna connection terminal is a terminal that is electrically connected to the first element 30 via the feed line 51. The antenna connection terminal corresponds to a terminal for transmitting/receiving high-frequency signals. The antenna connection terminal may be referred to as a signal terminal or a power supply terminal. Px shown in FIG. 1 and other drawings indicates a position of the antenna connection terminal. The position (Px) of the communication IC and the antenna connection terminal may be provided at an arbitrary position on the substrate 10. Px in the drawings may be interpreted as a land/location that is electrically connected to the antenna connection terminal.

The substrate 10 is a plate-shaped base material on which the various circuits and the ground plate 20 described above are arranged. The substrate 10 may be made of a dielectric. The substrate 10 may include an arbitrary insulating material, such as a prepreg made by impregnating fibers such as glass or carbon with resin and curing the fibers, or a solder resist. The substrate 10 may be a resin plate such as a printed wiring board. The substrate 10 may include a predetermined wiring pattern on its surface. The substrate 10 may be a multi-layer substrate having one or more conductive layers therein.

The substrate 10 has an area large enough to allow the ground plate 20, the first element 30, the second element 40, the feed line 51, the short-circuit line 52, the connector, the communication IC, and the like to be mounted on the substrate 10. The substrate 10 is formed in a rectangular shape. In other embodiments, the substrate 10 may be formed in a shape such as a square shape, an L-shape, a circular shape, a hexagonal shape, or the like. The substrate 10 may be provided with slits, screw holes for fixing to the housing, and the like.

The substrate 10 includes a first surface and a second surface. The first surface is a surface on which the first element 30 is mounted. The first surface may be referred to as a top surface. The second surface is a surface opposite to the first surface. The second surface may be referred to as a back surface or a bottom surface. A direction from the second surface toward the first surface corresponds to an upward direction of the antenna device 1.

The substrate 10 includes a first edge 11, a second edge 12, a third edge 13, and a fourth edge 14. The first edge 11 and the second edge 12 are edges that correspond to short sides of the rectangular shape. The first edge 11 and the second edge 12 are parallel to each other and have the same length. The third edge 13 and the fourth edge 14 are edges that correspond to long sides of the rectangular shape. The third edge 13 and the fourth edge 14 are parallel to each other and have the same length.

Hereinafter, a configuration of the antenna device 1 will be described by introducing a concept of a right-handed three-dimensional coordinate system having an X-axis, a Y-axis, and a Z-axis that are perpendicular to each other. The X-axis shown in various drawings such as FIG. 1 is parallel to a longitudinal direction of the substrate 10, and the Y-axis is parallel to a transverse direction of the substrate 10. The Z-axis is parallel to the up-down direction. In other embodiments, when the substrate 10 has a square shape, a direction along an arbitrary side of the substrate 10 may be set as the X-axis direction.

A direction from the first edge 11 toward the second edge 12 corresponds to a positive direction of the X-axis, and a direction from the third edge 13 toward the fourth edge 14 corresponds to a positive direction of the Y-axis. A length (Lx) of the substrate 10 in the X-axis direction corresponds to lengths of the third edge 13 and the fourth edge 14. A length (Ly) of the substrate 10 in the Y-axis direction corresponds to lengths of the first edge 11 and the second edge 12. For example, Lx is set to 55 mm, and Ly is set to 40 mm.

In other embodiments, Lx may be set to a value such as 50 mm, 60 mm, or 70 mm. Ly may be set to a value such as 25 mm, 30 mm, 35 mm, or 45 mm. The ratio of Ly to Lx (Ly/Lx) may be set to, for example, 0.4, 0.5, or 0.6. A shape of the substrate 10 may be designed to fit a mounted area.

The ground plate 20 is a conductive member having a plate shape and made of a conductor such as copper. The plate shape also includes a thin film shape such as a metal foil. The ground plate 20 may be a conductive layer formed on the surface of the substrate 10 by vapor deposition, electroplating, or the like. The ground plate 20 provides a ground potential (i.e., earth potential) for the antenna device 1 by being electrically connected to a ground electrode of a power cable via a power circuit, for example.

In this embodiment, the ground plate 20 is on the first surface of the substrate 10. In other embodiments, the ground plate 20 may be on the second surface or inside the substrate 10. The ground plate 20 may be a conductive layer arranged inside a multilayer substrate including multiple conductive layers and insulating layers.

The ground plate 20 has a rectangular shape. A length of short sides of the ground plate 20 is set to a value smaller than Ly, such as 20 mm or 25 mm. A length of long sides of the ground plate 20 is set to a value smaller than Lx, such as 50 mm or 55 mm. The lengths of the short and long sides of the ground plate 20 may be designed based on A. In order to stabilize operating frequency/gain, the length of the long sides of the ground plate 20 may be set to 0.5\ or more.

The ground plate 20 is attached to the substrate 10 in an orientation such that a longitudinal direction of the ground plate 20 is parallel to the longitudinal direction of the substrate 10. The ground plate 20 includes a first ground edge 21, a second ground edge 22, a third ground edge 23, and a fourth ground edge 24. The first ground edge 21 and the second ground edge 22 are parallel to the first edge 11 and the second edge 12. The third ground edge 23 and the fourth ground edge 24 are parallel to the third edge 13 and the fourth edge 14. The first edge 11, the first ground edge 21, the second ground edge 22, and the second edge 12 are arranged in this order in the positive direction of the X-axis. The third edge 13, the third ground edge 23, the fourth ground edge 24, and the fourth edge 14 are arranged in this order in the positive direction of the Y-axis.

The ground plate 20 is located at a position shifted toward the fourth edge 14 from a center of the substrate 10 so that the third ground edge 23 is away from the third edge 13 by a predetermined distance D1. D1 may be, for example, 20 mm. D1 may be, for example, 12 mm, 14 mm, 16 mm, 18 mm, 22 mm, or 24 mm. D1 may be set to a value such that an electromagnetic coupling between the three-dimensional antenna and the ground plate 20 can be reduced. D1 may be set to 0.1\ or greater.

Dimensions of the ground plate 20 may be changed appropriately in accordance with a shape and a size of the substrate 10. The ground plate 20 may have various shapes, such as a circular shape, a square shape, a hexagonal shape, an octagonal shape, or an L-shape. The rectangular shape includes a rectangle and a square. The circular shape may include not only a perfect circle but also an oval.

The first element 30 and the second element 40 are conductive members for transmitting or receiving a radio wave in the target frequency band. The first element 30 and the second element 40 are designed to operate cooperatively as a dipole antenna. In other words, the first element 30 is a linear conductor having a length of λ/4. The second element 40 is also a linear conductor having a length of λ/4. The cooperation between the first element 30 and the second element 40 may be interpreted as an electromagnetic coupling in one aspect. The first element 30 and the second element 40 are configured to form a current path of λ/2 by being combined with each other.

In the present disclosure, the term “linear” may be interpreted as a shape in which a width is sufficiently small compared to a length. The linear shape may include a belt shape or a rod shape. The linear conductor may be a conductive element having a width of 1 mm to several mm. The linear shape is not limited to a straight linear shape. The linear conductor may be formed in an L-shape, a meandering shape, a spiral shape. The linear shape also includes a shape having a certain thickness.

The first element 30 in the present embodiment is formed in the straight linear shape The first element 30 is positioned between the third ground edge 23 and the third edge 13 and parallel to the third edge 13. A distance between the first element 30 and the third edge 13 may be, for example, a few millimeters. The first element 30 is positioned within a range of 1 cm from the third edge 13 and parallel to the third edge 13 (i.e., the X-axis).

The first element 30 may be a conductor pattern formed on the first surface of the substrate 10 by printing or etching. As described above, the total length of the first element 30 corresponds to λ/4. Considering a wavelength shortening effect by the substrate 10, an apparent (actual) length of the first element 30 may be set to, for example, 25 mm.

The first element 30 includes a first end 31 and a second end 32. The first end 31 is an end of the first element 30 facing in the negative direction of the X-axis. The second end 32 is an end of the first element 30 facing in the positive direction of the X-axis. The first end 31 is connected to the communication IC via the feed line 51. The first end 31 may be interpreted as a substantial feed point for the three-dimensional antenna. The feed point may be interpreted as a connection point with the communication IC or the feed line 51. In the present embodiment, a direction in which the first element 30 extends from the feed point (i.e., the first end 31) is also referred to as a feed direction or a first extending direction. In the present embodiment, the positive direction of the X-axis corresponds to the feed direction or the first extending direction. The second end 32 is an open end. The first extending direction corresponds to a predetermined direction.

The second element 40 is a linear conductive member provided and standing on the substrate 10. The second element 40 may be referred to as a three-dimensional element. The second element 40 includes an apparent shape in which a bar-shaped metal part standing near the first end 31 is bent at a predetermined height position toward a direction in which the first element 30 is placed. The second element 40 may be, for example, a bar-shaped metal part having a width of several millimeters, a thickness of 0.5 to 1.0 mm, and a length of λ/4 and bent at a right angle by pressing or the like.

Since the portion of the second element 40 in contact with the substrate 10 is small, the second element 40 is less likely to be affected by the wavelength shortening effect. A total length of the second element 40 may be set to a value that approximately corresponds to λ/4, such as 30 mm. In other embodiments, the total length of the second element 40 may be set to be longer than λ/4.

The second element 40 includes a standing portion 41 and a substrate parallel portion 42. The standing portion 41 stands on the substrate 10 in the second element 40. The substrate parallel portion 42 is parallel to the substrate 10. An upper end of the standing portion 41 is connected to one end of the substrate parallel portion 42. The upper end of the standing portion 41 may be interpreted as a bent portion of the second element 40. The upper end of the standing portion 41 is also referred to as a third end 44 in the present disclosure. The third end 44 is also the one end of the substrate parallel portion 42.

A lower end 43 of the standing portion 41 is fixed to the substrate 10. The lower end 43 may be fixed to the substrate 10, for example, using a solder or a connector. Alternatively, an orientation of the second element 40 relative to the substrate 10 may be maintained by a pin-shaped insertion portion provided at the lower end 43 being inserted into a through hole in the substrate 10. The lower end 43 of the standing portion 41 may be referred to as a substrate joint portion or a root portion.

The lower end 43 of the standing portion 41 (i.e., substrate joint portion) is positioned in a vicinity of the first end 31. The vicinity of the first end 31 may be interpreted as a range within 5 mm or 10 mm of the first end 31. The vicinity of the first end 31 may be interpreted as a range within λ/12 from the first end 31. Conceptually, a range of distances in which the first element 30 and the second element 40 operate as a dipole antenna corresponds to the vicinity of the first end 31. The range that can be considered as the vicinity may depend on a performance requirement for the antenna.

The lower end 43 is positioned adjacent to the first end 31 with a predetermined distance in the negative direction of the X-axis from the first end 31. The lower end 43 may be provided at a position offset by a predetermined distance (D2) from the first end 31 in a direction opposite to the first extending direction. The smaller the distance D2 is, the higher a gain of the dipole antenna can be. As described above, D2 may be set to a few millimeters to 10 mm. D2 may be set to λ/12 or less. The lower end 43 is electrically connected to the ground plate 20 via the short-circuit line 52.

From another perspective, the above configuration corresponds to a configuration in which the lower end 43 and the first end 31 are arranged side by side in this order in a predetermined adjacent direction, and the first element 30 extends from the first end 31 in the adjacent direction. In the present embodiment, the first extending direction coincides with the adjacent direction. In other embodiments, the adjacent direction and the first extending direction may be perpendicular to each other.

The substrate parallel portion 42 extends from an upper end of the standing portion 41 (i.e., third end 44) in a direction in which the first element 30 is placed. The substrate parallel portion 42 may be interpreted as a linear conductor extending from the third end 44 in the first extension direction. A direction in which the substrate parallel portion 42 extends may be interpreted as a direction in which the metal part, which rises vertically from the substrate 10, is bent. The direction in which the substrate parallel portion 42 extends from the upper end of the standing portion 41 may be referred to as a bending direction. In the present disclosure, an end of the substrate parallel portion 42 located opposite the standing portion 41 is referred to as a fourth end 45.

In the top view, the substrate parallel portion 42 faces a part of the first element 30 as shown in FIG. 2. In other words, the substrate parallel portion 42 is parallel to a part of the first element 30. The substrate parallel portion 42 includes at least a portion that forms a current vector in a direction opposite to a current vector of the first element 30.

The standing portion 41 acts to radiate a substrate-vertically polarized wave isotropically in all directions perpendicular to the standing portion 41. The substrate-vertically polarized wave is a straight polarized wave in which a direction of the electric field oscillation is perpendicular to the substrate 10. The substrate parallel portion 42 acts to radiate a substrate-horizontally polarized wave isotropically in all directions perpendicular to the substrate parallel portion 42. The substrate-horizontally polarized wave is a straight polarized wave in which a direction of the electric field oscillation is parallel to the substrate 10.

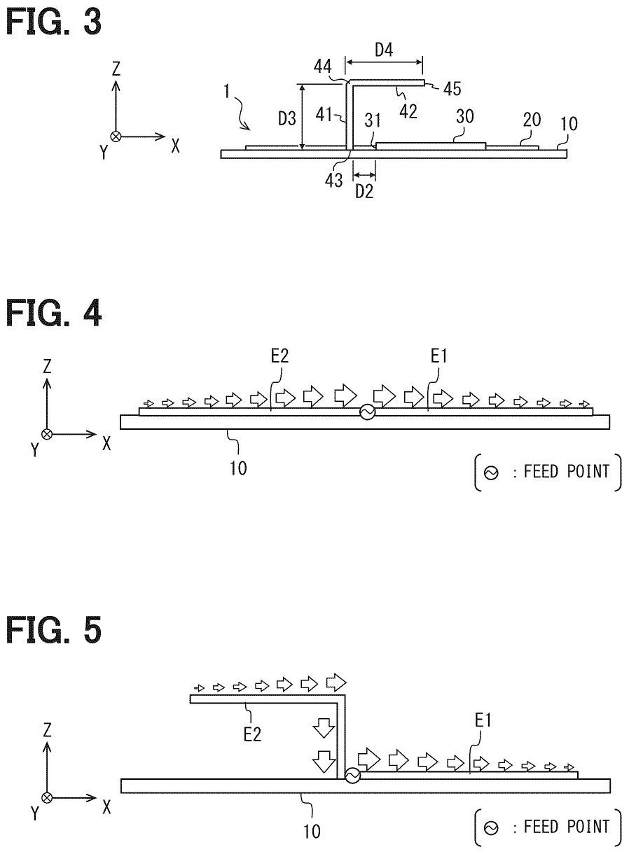

In FIG. 3, D3 represents a length of the standing portion 41, and D4 represents a length of the substrate parallel portion 42. D3 corresponds to a height of the second element 40. An aspect ratio of the second element 40, i.e., a ratio of a length of the standing portion 41 to a length of the substrate parallel portion 42 (D3:D4) may be set to 1:3, 1:2, 2:3, 3:4, or 1:1, for example.

The larger D3 is, the higher a gain in the substrate horizontal direction can be. The gain in the substrate horizontal direction means a gain in a horizontal direction for the three-dimensional antenna, i.e., a reception sensitivity/radiation intensity. The horizontal direction for the three-dimensional antenna is a direction parallel to the substrate 10. The gain in the substrate horizontal direction generally represents a gain in a direction perpendicular to the standing portion 41.

Additionally, the larger D3 is, the larger a height of the antenna device 1 is. Since a space available to accommodate the antenna device 1 in a vehicle has a limit, the height of the antenna device 1 may be restricted. D3 may be designed to meet this height restriction. Furthermore, the larger D3 is, the smaller D4 is, and as a result, a canceling effect by the substrate parallel portion 42, which will be described later, is weakened.

Considering the above circumstance, when the total length of the second element 40 is 30 mm, D3 may be set to a value between 4 mm and 20 mm. For example, D3 may be set to 6 mm, 8 mm, 10 mm, 12 mm, or 14 mm. When D3 is 10 mm, D4 is approximately 20 mm.

The feed line 51 is a microstrip line or a wiring pattern that electrically connects the communication IC and the first element 30. The feed line 51 may be interpreted as a linear conductor. One end of the feed line 51 is connected to the first end 31 of the first element 30, and the other end of the feed line 51 is connected to an antenna connection terminal of the communication IC. In the present embodiment, the feed line 51 is mounted on a surface of the substrate 10. In other embodiments, the feed line 51 may be a stripline inside the substrate 10.

The short-circuit line 52 is a microstrip line or a wiring pattern that electrically connects the ground plate 20 and the second element 40. One end of the short-circuit line 52 is connected to the lower end 43 of the second element 40, and the other end is connected to the ground plate 20. The short-circuit line 52 is mounted on the surface of the substrate 10. In other embodiments, the short-circuit line 52 may be a stripline inside the substrate 10.

### Interaction Between the First and Second Elements

Here, operations and effects of the antenna device 1 will be described using the first, second, and third models. Each model is configured to serve as a dipole antenna. Each model has a feed element E1 and a ground element E2. The feed element E1 is a linear conductor electrically connected to an antenna connection terminal of the communication IC. The ground element E2 is a linear conductor electrically connected to a member that provides a ground potential. Each length of the ground element E2 and the feed element E1 is set to λ/4. Each model has a current path of λ/2.

The first model has a basic configuration of a dipole antenna, as shown in FIG. 4. In other words, the first model has a configuration in which two linear elements having a length of λ/4 are arranged line-symmetrically. The current distribution in the basic dipole antenna is maximum at the feed point and minimum at opposite ends. The arrows illustrated in FIG. 4 conceptually indicate a direction and magnitude of the current. The first model has a doughnut-shaped radiation directivity that is rotationally symmetric with respect to the elements, or from another point of view, the first model has a figure-eight characteristic. Therefore, when the first model is formed on the substrate 10 to be parallel to the X-axis, the first model has isotropic directivity (in other words, omnidirectional) in a direction perpendicular to the X-axis. In the first model, no radio wave can be radiated in the X-axis direction. Moreover, the first model cannot radiate the substrate-vertically polarized wave.

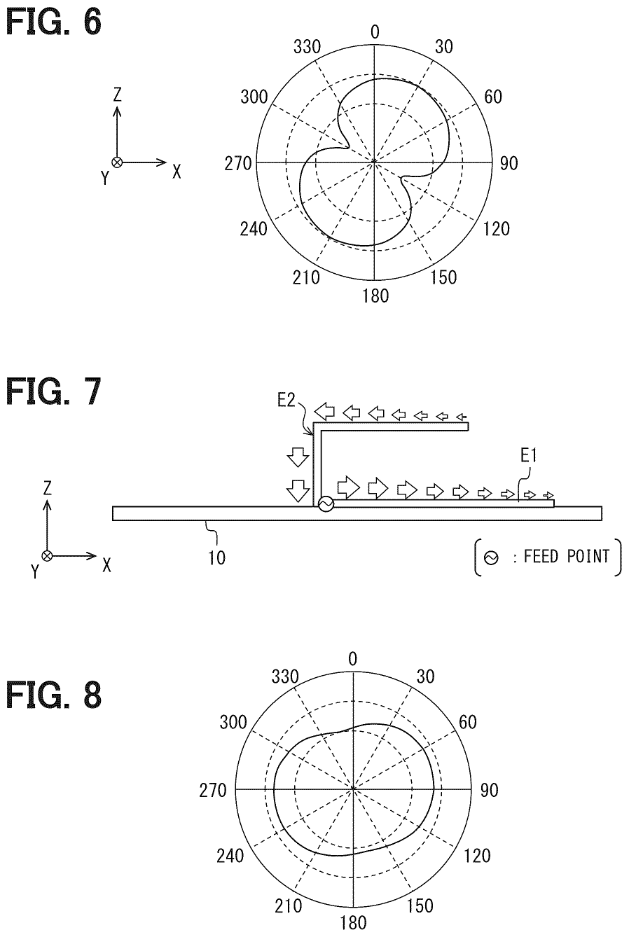

As illustrated in FIG. 5, the second model has a configuration in which the ground element E2 stands on the substrate 10 and is bent in an opposite direction to a direction in which the feed element E1 is placed. The second model has a portion perpendicular to the substrate 10 (i.e., standing portion). The standing portion contributes to radiation in the substrate horizontal direction. As a result, the second model can have an improved gain in the X-axis direction as shown in FIG. 6, compared to the first model. However, the second model has a characteristic in which a gain in a substrate perpendicular direction is larger than a gain in the substrate horizontal direction. The substrate perpendicular direction is a direction perpendicular to the substrate 10. In the second model, the substrate-horizontally polarized wave is mainly transmitted and received. In the second model, a gain of the substrate-vertically polarized wave is relatively small.

As illustrated in FIG. 7, the third model has a configuration in which the ground element E2 stands on the substrate 10, and the ground element E2 is bent in a direction in which the feed element E1 is placed. The third model corresponds to the antenna device 1 of the present embodiment. The third model also includes a portion perpendicular to the substrate 10 (i.e., standing portion) as well as the second model. Therefore, the third model can also radiate a radio wave in the substrate horizontal direction. Furthermore, a direction of a current flowing through a portion of the ground element E2 that is parallel to the substrate 10 (i.e., the substrate parallel portion) is opposite to a direction in which the current flows through the feed element E1.

In this way, in the third model, a current vector of the substrate parallel portion is opposite to a current vector of the feed element E1. The current flowing through the substrate parallel portion and the current flowing through the feed element E1 cancel each other out. In other words, the electric field formed by the current flowing through the substrate parallel portion and the electric field formed by the current flowing through the feed element E1 cancel each other out.

As a result, in the third model as illustrated in FIG. 8, a gain in the substrate vertical direction is lower and a gain in the substrate horizontal direction is higher, as compared with the second model. In the third model, the gain in the substrate horizontal direction can be made greater than the gain in the substrate vertical direction by adjusting of a dimensional ratio between the standing portion and the substrate parallel portion. Furthermore, according to the third model, it is possible to transmit and receive mainly the substrate-vertically polarized waves.

The third model has a configuration corresponding to the antenna device 1 of the present embodiment. Thus, as well as the third model, the antenna device 1 is also preferable for radiating of the substrate-vertically polarized wave toward the substrate horizontal direction. Furthermore, due to a reciprocity of transmission and reception, the antenna device 1 can satisfactorily receive the substrate vertical wave from the substrate horizontal direction.

Additionally, radio waves whose electric field vibration direction is perpendicular to a metal plate have a property of propagating along the metal plate. Thus, when the antenna device 1 is mounted in an orientation such that the substrate 10 faces the side body, the substrate-vertically polarized wave transmitted by the antenna device 1 is also likely to propagate along the side body, making it easier for the wave to reach areas outside the antenna device's line of sight, such as a rear area or a front area. The antenna device 1 can reduce a dead zone around the vehicle. The dead zone may be not only a spot where a radio wave cannot reach at all, but also a place where a radio wave is less likely to reach. The dead zone may be interpreted as an area where a radio wave strength is below a predetermined value, or an area where a communication failure rate (packet loss rate) is equal to or greater than a predetermined threshold.

### Modifications

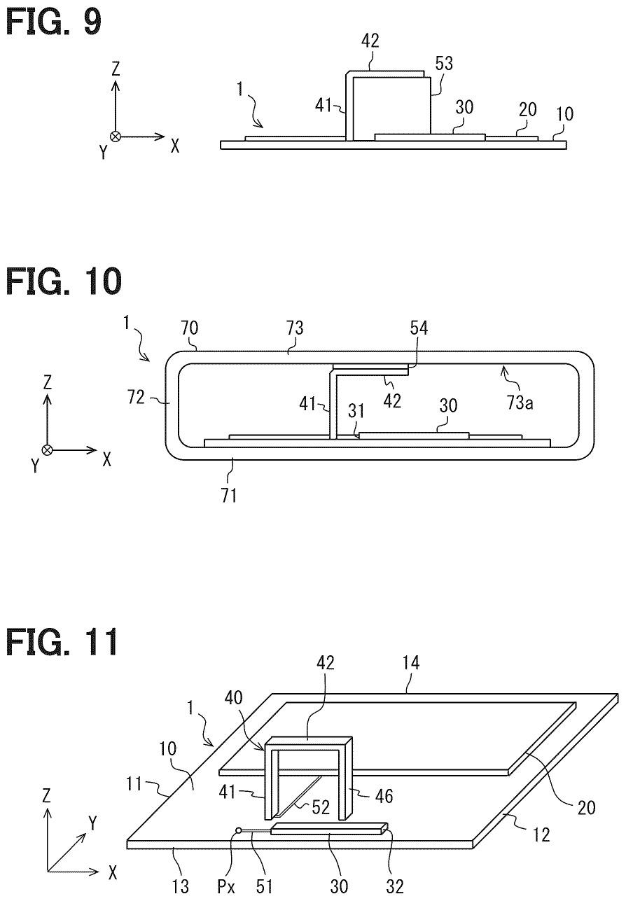

The second element 40 including the three-dimensional shape may be supported by a support member 53 as shown in FIG. 9. The support member 53 fixes the orientation of the substrate parallel portion 42 to the substrate 10. The support member 53 may be a resin block provided on an upper surface of the ground plate. The support member 53 may be one or more columns. The support member 53 may be secured to the substrate 10 with an insulating adhesive. The support member 53 may be integrated with the housing of the antenna device 1.

The second element 40 may be formed in a pattern on a surface of the support member 53. The second element 40 may be formed in a pattern on the surface of the support member 53 by a method such as electroplating, metal vapor deposition, or application of a conductive paint. In this case, the second element 40 on the support member 53 may include the lower end 43 in contact with the short-circuit line 52. The support member 53 fixing the second element 40 can reduce a risk of detachment of the second element 40 from the substrate 10 or changes in relative position between the second element 40 and the first element 30.

The antenna device 1 may include a housing 70 as shown in FIG. 10. A material of the housing 70 may be various resins such as polycarbonate (PC) resin or polypropylene (PP). The housing 70 may be divided into a bottom 71, a side wall 72, and a top plate 73, either physically or virtually. The bottom 71 forms a lower side face of the housing 70. The bottom 71 is substantially flat. The side wall 72 forms side faces of the housing 70 and stands upward from edges of the bottom 71. The top plate 73 forms an upper face of the housing 70. The top plate 73 may have a flat shape. An outer surface of the top plate 73 may include an arbitrary shape such as a dome shape. An inner ceiling surface 73a, which is an inner surface (back face) of the top plate 73, may have a flat shape facing the first surface of the substrate 10.

The housing 70 may include the inner ceiling surface 73a being in contact with the substrate parallel portion 42. The inner ceiling surface 73a can be made to be in contact with the substrate parallel portion 42 by adjusting of a height of the side wall 72. When the inner ceiling surface 73a is made to be in contact with the substrate parallel portion 42, the second element 40 can be made much smaller due to a wavelength shortening effect of the housing 70.

Additionally, the second element 40 may be fixed to the inner surface of the housing 70. For example, the substrate parallel portion 42 may be fixed to the inner ceiling surface 73a with an adhesive 54. This configuration also reduces the risk of changes in the relative position between the second element 40 and the first element 30 due to vibration or the like. Furthermore, the substrate parallel portion 42 may be patterned on the inner ceiling surface 73a by electroplating or the like. The standing portion 41 and the substrate parallel portion 42 do not necessarily have to be formed integrally. The second element 40 may be realized by abutting of the upper end of the standing portion 41 against the substrate parallel portion 42 that is vapor-deposited or bonded to the inner ceiling surface 73a.

The fourth end 45 of the substrate parallel portion 42 may be connected to the substrate 10 by a second standing portion 46 as shown in FIG. 11. The standing portion 41 corresponds to a first standing portion. The substrate parallel portion 42 may be supported by these two standing portions 41 and 46. The second element 40 may be formed in an inverted U-shape with corners that are approximately right angles. The U-shaped second element 40 may be realized by folding a bar-shaped or rod-shaped metal part twice. According to the above-mentioned configurations, the second element 40 and the substrate 10 are connected at two points, thereby improving the strength of the structure.

The lengths of the standing portions 41 and 46 may be the same. The standing portions 41 and 46 may be the same length as the substrate parallel portion 42. Of course, the substrate parallel portion 42 may be shorter than the standing portions 41 and 46. The lengths of the standing portions 41 and 46 may be the same as that of the first element 30. The total length of the second element 40 may be set to λ/2. The second element 40 may be designed so that the currents flowing through the standing portions 41 and 46 are in phase with each other. When the currents flowing through the standing portions 41 and 46 are in phase, the electric fields formed by the currents flowing through the standing portions 41 and 46 act to reinforce each other, so that gains of the standing portions 41 and 46 can be increased.

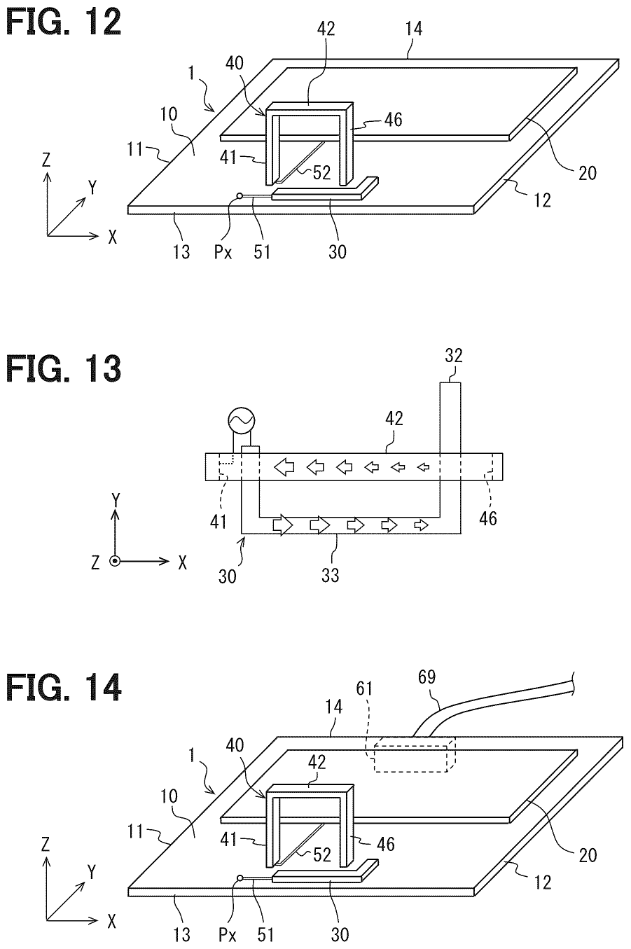

The first element 30 may be formed in an L-shape as shown in FIG. 12. It is preferable that the first element 30 has a section parallel to the substrate parallel portion 42 in the vicinity of the feed point. The first element 30 may be in a meandering shape, a spiral shape, or the like. If the first element 30 has a bent shape, the three-dimensional antenna can be made smaller.

As shown in FIG. 13, the first extending direction and the bending direction may be perpendicular to each other. In FIG. 13, the first extending direction is a negative direction of the Y-axis, and the bending direction is the positive direction of the X-axis. In the configuration shown in FIG. 13 as well, the current vector in the substrate parallel portion 42 is directed opposite to the current vector in the first folded portion 33 of the first element 30. Therefore, a cancellation effect can be obtained, and a gain in the direction perpendicular to the substrate can be reduced. Additionally, a gain in the horizontal direction of the substrate can be relatively increased.

A connector 61 to be connected to a cable 69 may be provided on an edge of the substrate 10 opposite to an edge on which the three-dimensional antenna is formed. In other words, the three-dimensional antenna may be formed near the edge opposite to the edge where the connector 61 is positioned. As shown in FIG. 14, when the connector 61 is positioned at the fourth edge 14, the three-dimensional antenna may be formed in a vicinity of the third edge 13. The vicinity of the third edge 13 may be interpreted as a range from a center of the substrate 10 to the third edge 13. The vicinity of the third edge 13 may be interpreted, specifically, as a range within 15 mm from the third edge 13. Additionally, FIG. 14 shows a configuration in which the connector 61 is positioned in a vicinity of the fourth edge 14 on the second surface of the substrate 10. The edge of the substrate 10 on which the connector 61 is arranged may be referred to as a connector arrangement edge. In the example shown in FIG. 14, the fourth edge 14 corresponds to the connector arrangement edge.

If the three-dimensional antenna and the connector 61 are close to each other, a current leaking to the cable 69 may reduce the gain of the three-dimensional antenna. In particular, when the size of the ground plate 20 is smaller than 0.5λ, performance degradation is likely to be caused by the current leaking to the cable 69. When the three-dimensional antenna is in the vicinity of the edge opposite to the connector arrangement edge, the antenna performance (e.g., gain) can be improved.

In the second and third models, even if the roles (connection destinations) of the first element 30 and the second element 40 are interchanged, similar characteristics can be obtained. In other words, in the antenna device 1, the second element 40 may be connected to the antenna connection terminal of the communication IC, and the first element 30 may be electrically connected to the ground plate 20.

A positional relationship of each component on the substrate 10, i.e., a layout, may be changed. The first element 30 and the second element 40 may be positioned in a vicinity of the first edge 11, the second edge 12, or the fourth edge 14. The ground plate 20 may be positioned on the second surface of the substrate 10, and the connector 61 or the communication IC or the like may be positioned on the first surface of the substrate. Furthermore, multiple three-dimensional antennas may be mounted on the first surface of the substrate 10 for diversity purposes.

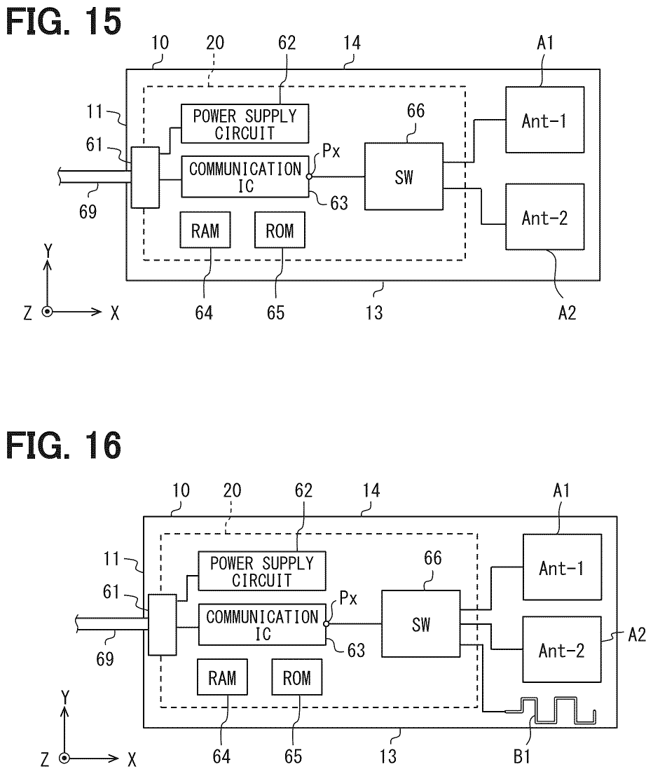

For example, as shown in FIG. 15, the antenna device 1 may have a configuration in which the connector 61 and the like are mounted on the first surface, and the ground plate 20 is formed on the second surface. In the antenna device 1 shown in FIG. 15, the connector 61, a power supply circuit 62, the communication IC 63, a RAM (Random Access Memory) 64, a ROM (Read Only Memory) 65, a switch 66, a first antenna A1, and a second antenna A2 are provided on the first surface.

In the antenna device 1 shown in FIG. 15, the connector 61 is positioned on the first edge 11. Therefore, in the configuration shown in FIG. 15, the first edge 11 corresponds to the connector arrangement edge. When the first edge 11 is the connector arrangement edge, a vicinity of the second edge 12 may be utilized as an antenna mounting space. The power supply circuit 62, the communication IC 63, the RAM 64, and the ROM 65 may be arranged between the first edge 11, which is the connector arrangement edge, and the center of the substrate 10.

Each of the first antenna A1 and the second antenna A2 is a three-dimensional antenna and includes the first element 30 and the second element 40. In the example shown in FIG. 15, the first antenna A1 and the second antenna A2 are arranged in parallel between the second edge 12 and the center of the substrate 10.

From as an aspect of diversity, the feeding direction of the first element 30 of the first antenna A1 may be perpendicular to that of the first element 30 of the second antenna A2. For example, when the feeding direction of the first element 30 of the first antenna A1 is parallel to the X-axis, the feeding direction of the first element 30 of the second antenna A2 may be parallel to the Y-axis. The feeding direction is a direction in which an element extends from the feed point, i.e., a tangential direction at the feed point.

The switch 66 is a switch circuit for switching the antenna connected to the antenna connection terminal of the communication IC 63. The switch 66 can take a first connection state in which the first antenna A1 is connected to the communication IC 63, and a second connection state in which the second antenna A2 is connected to the communication IC 63. The connection state of the switch 66 is changed by the communication IC 63. The switch 66 may be built into the communication IC 63. In this case, the communication IC 63 may include antenna connection terminals for each antenna.

As shown in FIG. 16, the antenna device 1 may include a third antenna B1 which is a pattern antenna, in addition to the first antenna A1 and the second antenna A2 which have the three-dimensional structures. The third antenna B1 may be a monopole antenna or a dipole antenna formed along the first surface. The first antenna A1 and the second antenna A2 are vertically polarized antennas that mainly support a substrate-vertically polarized wave, while the third antenna B1 can function as a horizontally polarized antenna that mainly supports a substrate-horizontally polarized wave.

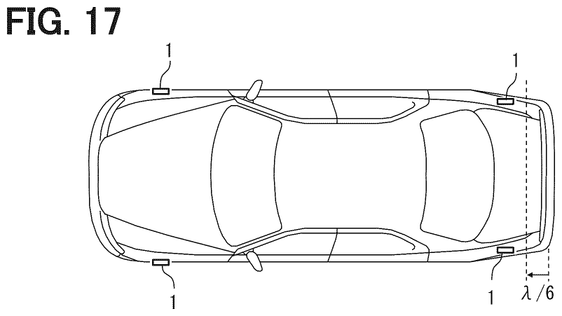

The antenna device 1 may be attached to a metal plate at a distance of λ/6 (approximately 20 mm) or more from a corner of a vehicle, as shown in FIG. 17. At a location that is λ/6 or more away from the corner, a three-dimensional antenna exhibits greater diffraction of radio waves into an area outside the line of sight compared to a dipole antenna patterned on the surface of the substrate. The antenna device 1 may be attached to, for example, a rear fender, a front fender, and a door panel. The antenna device 1 is not limited to being positioned on the side surface, but may also be positioned on the rear section or the front section. The rear section may include a space inside a rear door or a rear bumper. The front section may include a space, for example, inside a front bumper, inside a front grille, or behind an emblem.

Additionally, the antenna device 1 may include three or more vertically polarized antennas. Each of the three vertically polarized antennas may be the above-mentioned three-dimensional antenna including the first element 30 and the second element 40. Furthermore, one of the three or more vertically polarized antennas may be a zero-order resonant antenna. The zero-order resonant antenna is an antenna that has a basic structure of a metamaterial. The zero-order resonant antenna includes an opposing conductor plate, which is a flat metal conductor arranged to face the ground plate 20, and a short-circuit portion that electrically connects the center of the opposing conductor plate to the ground plate 20. The zero-order resonant antenna is an antenna that generates parallel resonance at a frequency determined by a capacitance between the ground plate 20 and a patch portion, and an inductance of the short circuit portion. The zero-order resonant antenna includes a mushroom structure. The zero-order resonant antenna may be interpreted as an antenna that applies metamaterial technology. A zero-order resonant antenna is sometimes referred to as a metamaterial antenna.

The term “parallel” in the present disclosure is not limited to a completely parallel state. A “parallel” state also includes a state where there is a tilt of several degrees to about 15 degrees. In other words, the term “parallel” can include a state where members are substantially parallel (i.e., substantially-parallel state). The term “perpendicular” in the present disclosure is not limited to a completely perpendicular state, and includes a state where there is a tilt of several degrees to about 15 degrees. The term “facing” in the present disclosure indicates a state where the members face each other with a predetermined distance. A facing state also includes a state where the members substantially face each other, such as an aspect where the members face each other while inclined by about 15 degrees.

The present disclosure also includes a wireless communication device and a wireless communication system using the above-described antenna device.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. An antenna device comprising:
a substrate that is a plate-shaped dielectric:
a ground plate that is a plate-shaped conductor provided on a surface of the substrate or inside the substrate;
a first element that is a liner conductive element extending along the surface of the substrate; and
a second element that is a liner conductive element having a three-dimensional shape, wherein
the second element includes
a standing portion perpendicular to the substrate, and
a substrate parallel portion extending from an upper end of the standing portion in a direction parallel to the substrate,
the substrate parallel portion includes a portion that is parallel to a part of the first element, and
one of ends: a lower end of the standing portion and an end of the first element, is connected to a feed line, and another of the ends is electrically connected to the ground plate.

2. The antenna device according to claim 1, wherein
the first element and the second element are configured to cooperate as a dipole antenna.

3. The antenna device according to claim 1, wherein
each length of the first element and the second element is set to a quarter of a target wavelength that is a wavelength of a radio wave to be transmitted or received by the antenna device.

4. The antenna device according to claim 1, wherein
the substrate parallel portion includes a first end connected to the standing portion, and a second end opposite to the first end,
the standing portion is a first standing portion, and
the second element further includes a second standing portion connecting the second end to the substrate.

5. The antenna device according to claim 4, wherein
a length of the first element is set to be a quarter of a target wavelength that is a wavelength of a radio wave to be transmitted of received by the antenna device, and
a length of the second element is set to be longer than the length of the first element.

6. The antenna device according to claim 1, wherein
the antenna device includes a housing that accommodates the substrate, and
the second element is fixed to an inner surface of the housing.

7. The antenna device according to claim 1, wherein
the substrate has a rectangular shape and includes four edges,
one of the four edges is a connector arrangement edge on which a connector is provided to be connected to a cable, and
the first element and the second element are positioned in a range from a center of the substrate to another of the four edges opposite to the connector arrangement edge.

8. The antenna device according to claim 1, wherein
the substrate includes multiple three-dimensional antennas each of which includes the first element and the second element.

9. The antenna device according to claim 1, wherein
the first element includes a first end and a second end,
the first end is electrically connected to the feed line or the ground plate,
the first end and the lower end is positioned adjacent to each other with a predetermined distance,
the first element extends from the first end in an adjacent direction that is a direction from the lower end toward the first end, and
the substrate parallel portion extends from an upper end of the standing portion in the adjacent direction.

10. The antenna device according to claim 1, wherein
the first element includes a first end and a second end,
the first end is electrically connected to the feed line or the ground plate,
the first element includes a liner part extending from the first end in a predetermined direction,
the lower end of the second element is positioned in a vicinity of the first end, and
the substrate parallel portion extends from an upper end of the standing portion in the predetermined direction.

11. The antenna device according to claim 1, wherein
the antenna device is attached to a metal part of a vehicle at a position at least one-sixth of a target wavelength away from a corner of the vehicle, and
the target wavelength is a wavelength of a radio wave to be transmitted or received by the antenna device.
